(19) United States
(12) Patent Application Publication
(10) Pub. No.: US 2010/0003493 A1
(43) Pub. Date: Jan. 7, 2010

(54) RADIATION CURABLE COATING COMPOSITIONS, RELATED COATINGS AND METHODS

(75) Inventors: Shan Cheng, Sewickley, PA (US); Thomas R. Hockswender, Gibsonia, PA (US)

Correspondence Address: PPG INDUSTRIES INC;INTELLECTUAL PROPERTY DEPT, ONE PPG PLACE, PITTSBURGH, PA, 15272, US

(73) Assignee: PPG Industries Ohio, Inc., Cleveland, OH (US)

(21) Appl. No.: 12/507,192

(22) Filed: Jul. 22, 2009

Related U.S. Application Data
(63) Continuation-in-part of application No. 12/247,260, filed on Oct. 8, 2008.
(60) Provisional application No. 60/978,886, filed on Oct. 10, 2007.

(51) Int. Cl. B32B 27/40; B05D 3/06; C08K 5/09

(52) U.S. Cl. 428/220; 427/487; 524/284; 428/423.1; 428/335

(57) ABSTRACT

Radiation curable coating compositions are disclosed. The radiation curable coating composition comprises a) an organic film-forming binder comprising (i) a urethane (meth)acrylate comprising the reaction product of reactants comprising a polyol and a polyisocyanate comprising at least two (meth)acrylate functional groups per molecule; and (ii) a highly functional (meth)acrylate; and b) a (meth)acrylate functional silsesquioxane dispersed in the binder. Also disclosed are related methods for coating a substrate, coated substrates and cured coatings formed from the radiation curable coating compositions.

### CROSS REFERENCE TO RELATED APPLICATIONS

This is a continuation-in-part of U.S. patent application Ser. No. 12/247,260 filed Oct. 8, 2008 (now pending), entitled “Radiation Curable Coating Compositions, Related Coatings and Methods”, which bears United States Publication No. US 2009/0098305 A1 published on Apr. 16, 2009 and claims the benefit of U.S. Provisional Application Ser. No. 60/978,886, filed Oct. 10, 2007, and which claims the benefit of this prior non-provisional application.

### FIELD OF THE INVENTION

The present invention relates to radiation curable coating compositions comprising a (meth)acrylate functional silsesquioxane, radiation cured coatings formed there from, related methods for coating a substrate, and related coated substrates.

### BACKGROUND OF THE INVENTION

Plastic substrates, including transparent plastic substrates, are desired for a number of applications, such as windshields, lenses, and consumer electronics devices, including, for example, cellular telephones, personal digital assistants, smart phones, personal computers, and digital cameras. To minimize scratching, as well as other forms of degradation, clear “hard coats” are often applied as protective layers to the substrates.

In some cases, such “hard coats” are formed from the hydrolysis and condensation of one or more alkoxysilanes. Coatings formed from such a mechanism can be very abrasion resistant. In certain industries, however, they are not as easily utilized as coatings that employ organic binder materials, such as organic binder materials curable upon exposure to actinic radiation.

More recently, hybrid organic-inorganic coatings have been proposed. These coatings employ particles, such as silica particles, dispersed in an organic binder, such as a UV curable organic binder; hence, their identification as “hybrid organic-inorganic” coatings. The hybrid organic-inorganic coatings developed thus far, however, have not exhibited the combination of very high initial clarity (low haze) at relatively high film thicknesses (up to 2 mils, i.e. 50 microns) and abrasion resistance required in certain applications, such as certain applications involving the use of such coatings on consumer electronic devices.

It would be desirable, therefore, to provide an improved radiation curable liquid coating composition that exhibits very high initial clarity (low haze) at relatively high film thicknesses (up to 2 mils, i.e. 50 microns) and abrasion resistance properties required in certain demanding applications. It has been discovered that the use of a particular radiation curable organic film-forming binder, in combination with a (meth)acrylate functional silsesquioxane, can achieve such a desirable combination of properties.

### SUMMARY OF THE INVENTION

In certain embodiments, the present invention is directed to radiation curable coating compositions. These compositions comprise: a) an organic film-forming binder comprising (i) a urethane (meth)acrylate comprising the reaction product of reactants comprising a polyol and a polyisocyanate comprising at least two (meth)acrylate functional groups per molecule, and (ii) a highly functional (meth)acrylate; and b) a (meth)acrylate functional silsesquioxane dispersed in the organic film-forming binder. In certain non-limiting embodiments, the compositions further comprise a highly functional (meth)acrylate selected from a tri functional (meth)acrylate, a tetra and/or higher functional (meth)acrylate, and mixtures thereof.

In other embodiments, the present invention is directed to radiation cured coatings. These cured coatings comprise: a) an organic film-forming binder comprising (i) a urethane (meth)acrylate comprising the reaction product of reactants comprising a polyol and a polyisocyanate comprising at least two (meth)acrylate functional groups per molecule, and (ii) a highly functional (meth)acrylate; and b) a (meth)acrylate functional silsesquioxane dispersed in the organic film-forming binder. The cured coatings have (1) a thickness of 3 to 50 microns; (2) an initial haze of <2%; and (3) a haze after 100 Taber cycles of <30%.

In other embodiments, the present invention is directed to methods for coating a substrate. These methods comprise: a) depositing onto at least a portion of a substrate a coating composition comprising: (1) an organic film-forming binder comprising (i) a urethane (meth)acrylate comprising the reaction product of a polyol and a polyisocyanate comprising two (meth)acrylate groups per molecule and (ii) a highly functional (meth)acrylate; and (2) a (meth)acrylate functional silsesquioxane dispersed in the organic film-forming binder; and b) curing the coating by exposing the coating to actinic radiation in air to produce a cured coating comprising: (1) a thickness of 3 to 50 microns, (2) an initial haze of <2.0%, and (3) a haze after 100 Taber cycles of <30%. In certain non-limiting embodiments, the compositions further comprise a highly functional (meth)acrylate selected from a tri functional (meth)acrylate, a tetra and/or higher functional (meth)acrylate, and mixtures thereof.

In still other embodiments, the present invention is directed to a substrate coated at least in part with a cured coating deposited from the radiation curable coating composition comprising a) an organic film-forming binder comprising (i) a urethane (meth)acrylate comprising the reaction product of reactants comprising a polyol and a polyisocyanate comprising at least two (meth)acrylate functional groups per molecule, and (ii) a highly functional (meth)acrylate; and b) a (meth)acrylate functional silsesquioxane dispersed in the organic film-forming binder.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As previously indicated, certain embodiments of the present invention are directed to coating compositions that comprise an organic film-forming binder. As used herein, the term “film-forming binder” refers to binders that can form a self-supporting continuous film on at least a horizontal surface of a substrate upon removal of any non-reactive diluents or carriers presented in the composition or upon curing at ambient or elevated temperature, or when exposed to actinic radiation. As used herein, the term “binder” refers to a continuous material in which the (meth)acrylate functional silsesquioxane is dispersed. As used herein, the term “organic film-forming binder” means that the film-forming binder comprises a backbone repeat unit based on carbon.

It is to be appreciated that in the following description of the coating compositions of the present invention, the weight percentages of the components when used in the radiation curable coating compositions are based on the total solids weight of the coating composition. However, when the weight percentages of the components are used in the radiation cured coating compositions they are based on the total weight of the cured coating compositions. Furthermore, the numerical values for the weight percentages of the components of the radiation curable coating compositions are generally the same for the weight percentages of the components of the radiation cured coating compositions.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

In certain embodiments, the radiation curable liquid coating is curable upon exposure to actinic radiation. “Actinic radiation” is light with wavelengths of electromagnetic radiation ranging from gamma rays to the ultraviolet (UV) light range, through the visible light range, and into the infrared range. Actinic radiation which can be used to cure certain coating compositions of the present invention generally has wavelengths of electromagnetic radiation ranging from 100 to 2,000 nanometers (nm), such as from 180 to 1,000 nm, or in some cases, from 200 to 500 nm. Examples of suitable ultraviolet light sources include mercury arcs, carbon arcs, low, medium or high pressure mercury lamps, swirl-flow plasma arcs and ultraviolet light emitting diodes. Preferred ultraviolet light-emitting lamps are medium pressure mercury vapor lamps having outputs ranging from 200 to 600 watts per inch (79 to 237 watts per centimeter) across the length of the lamp tube. In certain embodiments, the coating compositions of the present invention can be cured in air.

Materials that are curable upon exposure to actinic radiation include compounds with radiation-curable functional groups, such as unsaturated groups, including vinyl groups, vinyl ether groups, epoxy groups, maleimide groups, fumarate groups and combinations of the foregoing. In certain embodiments, the radiation curable groups are curable upon exposure to ultraviolet radiation and can include, for example, (meth)acrylate groups, maleimides, fumarates, and vinyl ethers. Suitable vinyl groups include those having unsaturated ester groups and vinyl ether groups.

In certain embodiments, the radiation curable liquid coating compositions of the present invention comprise a urethane (meth)acrylate and a highly functional (meth)acrylate as a binder, and a (meth)acrylate functional silsesquioxane dispersed in the binder. As used herein, the term “(meth)acrylate” is meant to encompass acrylates and methacrylates.

As used herein, the term “urethane (meth)acrylate” refers to a polymer that has (meth)acrylate functionality and that contains a urethane linkage. As will be appreciated, such a polymer can be prepared, for example, by reacting a polyisocyanate, a polyol, and a (meth)acrylate having hydroxyl groups, such as is described in U.S. Pat. No. 6,899,927 at column 4, lines 49 to 49, the cited portion of which is incorporated herein by reference.

In certain embodiments, the radiation curable liquid coating compositions of the present invention comprise a urethane (meth)acrylate comprising the reaction product of reactants comprising a polyol and a polyisocyanate having relatively few functional groups per molecule, often two (meth)acrylate functional groups per molecule. In some cases, such polymer has a molecular weight of 3,000. Another example of a “urethane (meth)acrylate polymer” is described in U.S. Pat. No. 6,899,927 at column 4, line 50 to column 5, line 3, the cited portion of which is incorporated herein by reference.

In certain embodiments, the urethane (meth)acrylate polymer is present in the radiation curable coating compositions of the present invention in an amount of at least 5 percent by weight, such as at least 10 percent by weight, with the weight percents being based on the total solids weight of the composition. In certain embodiments, the urethane (meth)acrylate polymer is present in the radiation curable coating compositions of the present invention in an amount of no more than 60 percent by weight, such as no more than 40 percent by weight, with the weight percents being based on the total solids weight of the composition. The amount of urethane (meth)acrylate polymer in the compositions of the present invention can range between any combination of the cited values inclusive of the recited values.

In certain embodiments, the radiation curable liquid coating compositions of the present invention comprise a (meth)acrylate functional silsesquioxane. As known in the art, in general, silsesquioxanes have a ceramic (silicon-oxygen) backbone with organic groups attached. The empirical chemical formula is RSiO_{1.5} where Si is the element silicon, O is oxygen and R represents the organic group, including (meth)acrylates. The silsesquioxane may be a ladder structure or a cage structure. In the present invention, a silsesquioxane can be functionalized with (meth)acrylate groups and can be of a cage structure containing 8 Si atoms. The (meth)acrylate functional silsesquioxane is reactive in that it is readily cross-linked with the organic film-forming binder components, particularly, with the highly functional (meth)acrylate. The (meth)acrylate functional silsesquioxane used in the compositions of the present invention can be in liquid form.

In certain embodiments, the (meth)acrylate functional silsesquioxane is present in the radiation curable coating compositions of the present invention in an amount of at least 5 percent by weight, such as at least 10 percent by weight, with the weight percents being based on the total solids weight of the composition. In certain embodiments, the (meth)acrylate functional silsesquioxane is present in the radiation curable coating compositions of the present invention in an amount of no more than 80 percent by weight, such as no more than 60 percent by weight, with the weight percents being based on the total solids weight of the composition. In still further embodiments, the (meth)acrylate functional silsesquioxane is present in the radiation curable coating compositions of the present invention in an amount ranging between 10 and 40 percent by weight, based on the total solids weight of the composition. The amount of (meth)acrylate functional silsesquioxane in the radiation curable coating compositions of the present invention can range between any combination of the cited values inclusive of the recited values.

A suitable (meth)acrylate functional silsesquioxane is available from The Welding Institute (TWI), Cambridge, UK.

A further example of a (meth)acrylate functional silsesquioxane suitable for use in the invention is described in United States Publication No. 2007/0122636 A1 at [0025] to [0089], the cited portions of which being incorporated herein by reference.

In certain embodiments, the radiation curable liquid coating compositions of the present invention comprise a highly functional (meth)acrylate. As used herein, the term “highly functional (meth)acrylate” refers to (meth)acrylates having three or more (meth)acrylate, often acrylate, functional groups per molecule, such as tri-, tetra-, penta-, and/or hexa-functional (meth)acrylates.

In certain embodiments, the radiation curable liquid coating compositions of the present invention comprise a tri-functional (meth)acrylate. As used herein, the term “tri functional (meth)acrylate” is meant to encompass (meth)acrylate monomers and polymers comprising three reactive (meth)acrylate groups per molecule. Examples of such compounds, which are suitable for use in the present invention, are propoxylated glyceryl triacrylate, ethoxylated trimethylolpropane triacrylate, pentacrythritol triacryalate, propoxylated glyceryl triacrylate, propoxylated trimethylolpropane triacrylate, trimethylolpropane triacrylate, trimethylolpropane trimethacrylate, tris (2-hydroxy ethyl) and/or isocyanurate triacrylate.

In certain embodiments, the total amount of tri functional (meth)acrylate present in the radiation curable coating compositions of the present invention is at least 5 percent by weight, such as at least 10 percent by weight, with the weight percents being based on the total solids weight of the coating composition In certain embodiments, the total amount of tri functional (meth)acrylate present in the radiation curable coating compositions of the present invention is no more than 80 percent by weight, such as no more than 60 percent by weight, with the weight percents being based on the total solids weight of the coating composition. The total amount of tri functional (meth)acrylate present in the radiation curable coating compositions of the present invention can range between any combination of the recited values inclusive of the recited values.

In certain embodiments, the radiation curable coating compositions of the present invention comprise a tetra and/or higher functional (meth)acrylate. As used herein, the phrase “tetra and/or higher functional (meth)acrylate” is meant to encompass (meth)acrylate monomers and polymers comprising four or more reactive (meth)acrylate groups per molecule, such as tetra-, penta-, and/or hexa-functional (meth)acrylates.

As used herein, the term “tetra functional (meth)acrylate” is meant to encompass (meth)acrylates comprising four reactive (meth)acrylate groups per molecule. Examples of such materials, which are suitable for use in the present invention, include, but are not limited to, di-trimethlolpropane tetraacrylate, ethoxylated 4-pentacrythritol tetraacrylate, pentacrythritol ethoxylate tetraacrylate, pentacrythritol propoxylate tetraacrylate, including mixtures thereof.

As used herein, the term “penta functional (meth)acrylate” is meant to encompass (meth)acrylate monomers and polymers comprising five reactive (meth)acrylate groups per molecule. Suitable examples of such materials include, but are not limited to, dipentacrythritol pentaacrylate, dipentacrythritol ethoxylate pentaacrylate, and dipentacrythritol propoxylate pentaacrylate, including mixtures thereof.

As used herein, the term “hexa functional (meth)acrylate” is meant to encompass (meth)acrylate monomers and polymers comprising six reactive (meth)acrylate groups per molecule. Suitable examples of such materials include, but are not limited to, commercially available products such as EBECRYL™ 1290 and EBECRYL™ 8301 hexafunctional aliphatic urethane acrylate (both available from Cytec); EBECRYL™ 220 hexafunctional aromatic urethane (available from Cytec); EBECRYL™ 830, EBECRYL™ 835, EBECRYL™ 870 and EBECRYL™ 2870 hexafunctional polyester acrylates (all available from Cytec); EBERCRYL™ 450 fatty acid modified polyester hexaacrylate (available from Cytec); DPHA™ dipentacrythritol hexaacrylate (functionality 6; available from Cytec) and mixtures of any of the foregoing.

In certain embodiments, the tetra and/or higher functional (meth)acrylate is present in the radiation curable coating compositions of the present invention in an amount of at least 5 percent by weight, such as at least 10 percent by weight, based on the total solids weight of the coating compositions of the invention. In certain embodiments, the tetra and/or higher functional (meth)acrylate is present in the radiation curable coating compositions of the present invention in an amount of no more than 80 percent by weight, such as no more than 60 percent by weight, based on the total solids weight of the coating compositions. The amount of tetra and/or higher functional (meth)acrylate in the radiation curable coating compositions of the present invention can range between a combination of the recited values inclusive of the recited values.

In certain embodiments, the radiation curable coating compositions of the present invention may be substantially free or, in some cases, completely free of mono (meth)acrylates. As used herein, the term “mono (meth)acrylate” encompasses monomers and polymers comprising one (meth)acrylate group per molecule. In certain embodiments, the radiation curable coating compositions of the present invention comprise di(meth)acrylates. As used herein, the term “di(meth)acrylate” encompasses monomers and polymer comprising two (meth)acrylate groups per molecule.

In certain embodiments, the coating compositions of the present invention further comprise an organic solvent. The amount of organic solvent present may range from 20 to 90 weight percent based on the total weight of the coating composition, depending on the particular composition used and the desired application technique. Suitable solvents include, but are not limited to, the following: benzene, toluene, methyl ethyl ketone, methyl isobutyl ketone, acetone, ethanol, tetrahydrofurfuryl alcohol, propyl alcohol, butyl alcohol, propylene carbonate, N-methylpyrrolidinone, N-vinylpyrrolidinone, N-acetylpyrrolidinone, N-hydroxymethylpyrrolidinone, N-butyl-pyrrolidinone, N-ethylpyrrolidinone, N-(N-octyl)-pyrrolidinone, N-(n-dodecyl) pyrrolidinone, 2-methoxyethyl ether, xylene, cyclohexane, 3-methylcyclohexanone, ethyl acetate, butyl acetate, tetrahydrofuran, methanol, amyl propionate, methyl propionate, diethylene glycol monobutyl ether, dimethyl sulfoxide, dimethyl formamide, ethylene glycol, mono and dialky ethers of ethylene glycol and their derivatives, which are sold as CELLOSOLVE industrial solvents by Union Carbide, propylene glycol methyl ether and propylene glycol methyl ether acetate, which are sold as DOWANOL® PM and PMA solvents, respectively, by Dow Chemical and mixtures of such cited solvents.

Depending on the desired application technique, the coating compositions of the present invention may be embodied as a liquid coating composition that is substantially solvent-free and water-free, i.e. substantially 100% solids coatings. As used herein, the term “substantially 100% solids” means that the composition contains substantially no volatile organic solvent (VOC), and has essentially zero emissions of VOC, and contains substantially no water. In certain embodiments, the substantially 100% solids coatings of the present invention comprise less than 5 percent VOC and water by weight of the coating composition, in some cases less than 2 percent by weight of the coating composition, in yet other cases, less than 1 percent by weight of the coating composition, and in yet other cases, VOC and water are not present in the coating composition at all.

In certain embodiments, the coating compositions of the present invention may also comprise additional optional ingredients, such as those ingredients well known in the art of formulating surface coatings. Such optional ingredients may comprise, for example, surface active agents, photoinitiators, flow control agents, thixotropic agents, anti-gassing agents, antioxidants, light stabilizers, UV absorbers and other customary auxiliaries. Any such additives known in the art can be used.

In certain embodiments, particularly when the coating compositions of the present invention are to be cured by UV radiation, the compositions also comprise a photoinitiator, which may be one type of photoinitiator or a mixture of several kinds of photoinitiators. As will be appreciated by those skilled in the art, a photoinitiator absorbs radiation during cure and transforms it into chemical energy available for the polymerization. Photoinitiators are classified in two major groups based upon a mode of action, either or both of which may be used in the compositions of the present invention. Cleavage-type photoinitiators include acetophenone, alpha-aminoalkylphenones, benzoin ethers, benzoyl oximes, acylphosphine oxides and bisacylphosphine oxides and mixtures thereof. Abstraction-type photoinitiators include benzophenone, Michler's ketone, thioxanthone, anthraquinone, camphorquinone, fluorone, ketocoumarin and mixtures thereof.

Specific non-limiting examples of photoinitiators that may be used in certain embodiments of the coating compositions of the present invention include benzyl, benzoin, benzoin methyl ether, benzoin isobutyl ether benzophenol, acetophenone, benzophenone, 4,4′-dichlorobenzophenone, 4,4′-bis(N,N′-dimethylamino) benzophenone, diethoxyacetophenone, fluorones, e.g. the H-Nu series of initiators available from Spectra Group Ltd., 2-hydroxy-2-methyl-1-phenylpropan-1-one, 1-hydroxycyclohexyl phenyl ketone, 2-isopropylthixantone, α-aminoalkylphenone, e.g., 2-benzyl-2-dimethylamino-1-(4-morpholinophenyl)-1-butanone, acylphosphine oxides, e.g., 2,6-dimethylbenzoyldlphenyl phosphine oxide, 2,4,6-trimethylbenzoyldiphenylphosphine oxide, bis(2,4,6-trimethylbenzoyl)phenyl phosphine oxide, 2,6-dichlorobenzoyl-diphenylphosphine oxide, and 2,6-dimethoxybenzoyldiphenylphosphine oxide, bisacylphosphine oxides, e.g. bis(2,6-dimethyoxybenzoyl)-2,4,4-trimethylepentylphosphine oxide, bis(2,6-dimethylbenzoyl)-2,4,4-trimethylpentylphosphine oxide, bis(2,4,6-trimethylbenzoyl)-2,4,4-trimethylpentylphosphine oxide, and bis(2,6-dichlorobenzoyl)-2,4,4-trimethylpentylphosphine oxide, and mixtures thereof.

In certain embodiments, the coating compositions of the present invention comprise 0.01 up to 15 percent by weight of photoinitiator or, in some embodiments, 0.01 up to 10 percent by weight, or, in yet other embodiments, 0.01 up to 5 percent by weight of photoinitiator based on the total solids weight of the coating composition. The amount of photoinitiator present in the coating compositions can range between combinations of these values inclusive of the recited values.

In certain embodiments, the coating compositions of the present invention further comprise a colorant. As used herein, the term “colorant” means any substance that imparts color and/or other opacity and/or other visual effect to the composition. The colorant can be added to the coating in any suitable form, such as discrete particles, dispersions, solutions, and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quianacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (DPPBO red), titanium dioxide, carbon black and mixtures thereof. The terms “pigment” and colored filler” can be used interchangeably.

Example dyes include, but are not limited to, those that are solvent and/or aqueous based, such as pthalo green or blue, iron oxide, bismuth vanadate, anthraquinone, perylene, aluminum and quinacridone.

Example tints include, but are not limited to, pigments dispersed in waterbased or water miscible carriers such as AQUA-CHEM 896 commercially available from Degussa, Inc., CHARISMA COLORANTS and MAXITONER INDUSTRIAL COLORANTS commercially available from Accurate Dispersions, a division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference in its entirety. Nanoparticle dispersions can also be produced by crystallization, precipitation, gas phase condensation, and chemical attrition (i.e. partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discrete “composite microparticles” that comprise a nanoparticle and a resin coating on the nanoparticle. Example dispersions of resin-coated nanoparticles and methods for making them are identified in United States Patent Application Publication 2005/0287348 A1 filed Jun. 24, 2004; U.S. Provisional Application No. 60/482,167 filed Jun. 24, 2003; and U.S. patent application Ser. No. 11/337,062, filed Jan. 20, 2006, which are being incorporated herein by reference.

Example special effect compositions that may be used in the compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference in its entirety. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in any amount sufficient to impart the desired visual and/or color effect. The colorant may comprise from 0.1 to 65 weight percent of the present compositions, such as from 0.1 to 10 weight percent or 0.5 to 5 weight percent, with weight percent based on the total solids weight of the compositions of the present invention.

The coating compositions of the present invention can be prepared by any suitable technique, including those described in the Examples herein. The coating components can be mixed using, for example, stirred tanks, dissolvers, including inline dissolvers, bead mills, stirrer mills, and static mixers. Where appropriate, it is carried out with exclusion of actinic radiation in order to prevent damage to the coating of the invention which is curable with actinic radiation. In the course of preparation, the individual constituents of the mixture according to the invention can be incorporated separately. Alternatively, the mixture of the invention can be prepared separately and mixed with the other constituents.

The coating compositions of the present invention can be applied to any suitable substrate, however, in many cases, the substrate is a plastic substrate, such as thermoplastic substrate, including, but not limited to, polycarbonate, polymethyl methacrylate, acrylonitrile butadiene styrene, blends of polyphenylene ether and polystyrene, polyetherimide, polyester, polysulfone, acrylic, and copolymers and/or blends thereof.

Prior to applying the coating composition to such a substrate, the substrate surface may be treated by cleaning. Effective treatment techniques for plastics include ultrasonic cleaning; washing with an aqueous mixture of organic solvent, e.g., a 50:50 mixture of isopropanol:water or ethanol:water; UV treatment; activated gas treatment, e.g., treatment with low temperature plasma or corona discharge, and chemical treatment such as hydroxylation, i.e., etching of the surface with an aqueous solution of alkali, e.g., sodium hydroxide or potassium hydroxide, that may also contain a fluorosurfactant. See U.S. Pat. No. 3,971,872, column 3, lines 13 to 25; U.S. Pat. No. 4,904,525, column 6, lines 10 to 48; and U.S. Pat. No. 5,104,692, column 13, lines 10 to 59, which describe surface treatments of polymeric organic materials.

The coating compositions of the present invention may be applied to the substrate using, for example, any conventional coating technique including flow coating, dip coating, spin coating, roll coating, curtain coating and spray coating. Application of the coating composition to the substrate may, if desired, be done in an environment that is substantially free of dust or contaminants, e.g. a clean room. Coatings prepared by the process of the present invention may range in thickness from 0.1 to 50 microns (μm). However, it has been discovered that coating thicknesses of from 3 to 25 microns (μm) can be critical to achieving the transparency and abrasion resistance properties described below.

Following application of a coating composition of the present invention to the substrate, the coating is cured, such as by exposing, in air, the coated substrate to the actinic radiation conditions described herein above. As used herein, the terms “cured” and “curing” refer to the at least partial crosslinking of the components of the coating that are intended to be cured, i.e., cross-linked. In certain embodiments, the crosslink density, i.e., the degree of crosslinking, ranges from 35 to 100 percent of complete crosslinking. The presence and degree or crosslinking, i.e., the crosslink density, can be determined by a variety of methods, such as dynamic mechanical thermal analysis (DMTA) using a Polymer Laboratories MK IIII DMTA analyzer, as is described in U.S. Pat. No. 6,803,408, at column 7, line 66 to column 8, line 18, the cited portion of which being incorporated herein by reference.

In certain embodiments, the coatings formed from the coating compositions of the present invention are abrasion resistant and exhibit excellent initial clarity at film thicknesses up to 2 mils, i.e. 50 microns (μm). For purposes of the present invention, the term “initial clarity” means that the cured coating has an initial % haze, prior to any Taber abrasion, of less than 5%, in some cases, less than 2%. For purposes of the present invention, the term “abrasion resistant” means that the cured coating has a % haze of less than 30%, in some cases less than 20%, when measured after 100 Taber abrasion cycles in accordance with a standard Taber Abrasion Test (ASTM D 1044-49 modified by using the conditions described in the Examples).

The following examples illustrate the invention. However, these examples are not to be considered as limiting the invention to their details. Unless otherwise indicated, all parts and percentages in the following examples, as well as throughout the specification, are by weight.

### EXAMPLES

### Example 1

A radiation curable coating composition 1 was prepared as a control coating from the ingredients listed in Table 1. Charge I was added to a suitable flask and stirred. Charge II was then added to the flask and the mixture of Charge I and Charge II was stirred until the solids had dissolved. Charge III was then added to the mixture of Charge I and Charge II under continued agitation.

TABLE 1

| Charge | Component | Formula Weight (in grams) |
|---|---|---|
| I | Polyurethane diacrylate¹ | 110.15 |
| | Sartomer SR399² | 83.51 |
| | Sartomer SR454³ | 70.13 |
| II | Daracure 1173⁴ | 12.03 |
| | Irgacure 184⁵ | 1.46 |
| | Genocure MBF⁶ | 1.51 |
| | Benzophenone⁷ | 8.84 |
| III | PM Acetate⁸ | 45.23 |
| | n-butyl acetate9 | 158.30 |
| | Isobutanol¹⁰ | 113.07 |
| | BYK-UV 3500¹¹ | 0.48 |
| | Modaflow 2100¹² | 1.04 |
| | TEGOrad 2100¹³ | 5.19 |

¹A 73% solids solution in organic solvent of a polyurethane acrylate resin having a molecular weight of about 3,000 comprising the reaction product of a polyol and a polyisocyanate comprising two acrylate groups per molecule.
²Dipentaerythritol pentaacrylate commercially available from Sartomer Company, Inc., Exton, PA.
³Ethoxylated trimethylolpropane triacrylate commercially available from Sartomer Company, Inc., Exton, PA.
⁴Photoinitiator commercially available from CIBA Specialty Chemicals.
⁵Photoinitiator commercially available from CIBA Specialty Chemicals.
⁶Photoinitiator commercially available from Rahn, Inc.
⁷Photoinitiator.
⁸Propylene glycol monomethyl ether acetate - a slow evaporating solvent with ether and ester functional groups.
⁹Solvent.
¹⁰Solvent.
¹¹Polyether modified acryl functional polydimethylsiloxane (surface additive) commercially available from Byk-Chemie.
¹²Flow modifier commercially available from Cytec Surface Specialties.
¹³ Flow modifier commercially available from Tego Chemie, Essen, Germany.

### Examples 2, 3, 4

As shown in Table 2, radiation curable clear coat coating compositions of examples 2, 3, 4 were prepared by adding varied amounts of the acrylate silsesquioxane to the coating composition of Example 1 respectively under agitation. The mixture was stirred for an appropriate time to form a clear solution.

TABLE 2

| | Formula Weight (in grams) | | |
|---|---|---|---|
| Component | Example 2 | Example 3 | Example 4 |
| Coating composition of | 50.00 | 50.00 | 50.00 |
| Example 1 | | | |
| Acrylate silsesquioxane¹ | 7.24 | 11.69 | 21.71 |

¹An acrylate functionalized silsesquioxane obtained from The Welding Institute, Cambridge, UK.

In order to coat samples with the foregoing compositions, Makrolon® transparent polycarbonate plaques (Bayer AG) were wiped with 2-propanol. The coating solutions were spin applied on the un-primed substrate and cured with an H bulb with UVA dosage of 1 J/cm² and an intensity of 0.6 W/cm² under air. The samples with a final dry film thickness around 15.0 microns (μm) were prepared. The coated samples were evaluated for optical clarity and abrasion resistance.

As demonstrated in Table 3, the polycarbonate samples coated with the acrylate coating systems containing the acrylate silsesquioxane of the present invention exhibited a higher level of abrasion resistance compared to the control coating composition of Example 1 without the acrylate silsesquioxane.

TABLE 3

| | Results | | | |
|---|---|---|---|---|
| Testing | Example 1 | Example 2 | Example 3 | Example 4 |
| Appearance | Clear | Clear | Clear | Clear |
| Initial Haze %¹ | 0.2 | 1.5 | 1.3 | 1.4 |
| Haze % after 100 cycles | 35.5 | 27.0 | 16.8 | 19.0 |
| of Taber Abrasion² | | | | |

¹Haze % was measured with Hunter Lab spectrophotometer.
²Taber Abrasion: Taber 5150 Abrader, CS-10 wheels, S-11 refacing disk, 500 grams of weight. Haze % was measured after 100 Taber cycles.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A radiation curable coating composition, comprising:
a) an organic film-forming binder comprising:
(i) a urethane (meth)acrylate comprising the reaction product of reactants comprising a polyol, and a polyisocyanate comprising at least two (meth)acrylate functional groups per molecule; and
(ii) a highly functional (meth)acrylate; and
b) a (meth)acrylate functional silsesquioxane dispersed in the organic film-forming binder.

2. The coating composition of claim 1, wherein the urethane (meth)acrylate comprises polyurethane diacrylate.

3. The coating composition of claim 1, wherein the highly functional (meth)acrylate is selected from a tri functional (meth)acrylate, a tetra and/or higher functional (meth)acrylate, and mixtures thereof.

4. The coating composition of claim 1, wherein the (meth)acrylate functional silsesquioxane is in the coating composition in an amount of at least 5 weight percent, based on the total solids weight of the coating composition.

5. The coating composition of claim 1, wherein the (meth)acrylate functional silsesquioxane is in the coating composition in an amount ranging from 5 to 80 weight percent, based on the total solids weight of the coating composition.

6. The coating composition of claim 1, wherein the (meth)acrylate functional sillsesquioxane is in the coating composition in an amount ranging from 10 to 60 weight percent, based on the total solids weight of the coating composition.

7. The coating composition of claim 1, wherein a cured coating formed from the coating composition has a % haze of less than 30% when measured after 100 Taber abrasion cycles in accordance with ANSI/SAE 26.1-1996.

8. A substrate coated at least in part with a cured coating deposited from the coating composition of claim 1.

9. The substrate of claim 8 wherein the substrate comprises plastic.

10. A radiation cured coating comprising:
a) an organic film-forming binder comprising (i) an urethane (meth)acrylate comprising the reaction product of reactants comprising a polyol and a polyisocyanate comprising at least two (meth)acrylate functional groups per molecule, and (ii) a highly functional (meth)acrylate; and
b) a (meth)acrylate functional silsesquioxane dispersed in the organic film-forming binder, wherein the cured coating has:
(1) a thickness of 3 to 50 microns;
(2) an initial haze of <2%; and
(3) a haze after 100 Taber cycles of <30%.

11. The cured coating of claim 10 wherein the (meth)acrylate functional silsesquioxane is present in the coating composition in an amount of at least 5 weight percent based on the total weight of the cured coating composition.

12. The cured coating of claim 10 wherein the (meth)acrylate functional silsesquioxane is present in the coating composition in an amount ranging between 5 and 80 weight percent based on the total weight of the cured coating composition.

13. The cured coating of claim 10 wherein the (meth)acrylate functional silsesquioxane is present in the coating composition in an amount ranging between 10 and 60 weight percent based on the total weight of the cured coating composition.

14. The cured coating of claim 10 wherein the cured coating is deposited on a plastic substrate.

15. A method of coating a substrate, comprising:
(a) depositing onto at least a portion of a substrate a coating composition comprising:
(1) a radiation curable organic film-forming binder comprising: (i) a urethane (meth)acrylate comprising the reaction product of a polyol and a polyisocyanate comprising two (meth)acrylate groups per molecule and (ii) a highly functional (meth)acrylate; and
(2) a (meth)acrylate functional silsesquioxane dispersed in the organic film-forming binder; and
(b) curing the coating composition by exposing the coating composition to actinic radiation in air to produce a cured coating composition comprising:
(1) a thickness of 3 to 50 microns,
(2) an initial haze of <2.0%, and
(3) a haze after 100 Taber cycles of <30%.

16. The method of claim 15, wherein the substrate comprises a plastic substrate.

17. The method of claim 15, wherein the coating composition further comprises a highly functional (meth)acrylate selected from a tri functional (meth)acrylate, a tetra and/or higher functional (meth)acrylate, and mixtures thereof.

18. The method of claim 15, wherein the (meth)acrylate functional silsesquioxane is present in the coating composition in an amount of at least 5 weight percent, based on the total weight of the coating composition.

19. The method of claim 15 wherein the (meth)acrylate functional silsesquioxane is present in the coating composition in an amount ranging from 5 to 80 weight percent based on the total weight of the coating composition.

20. The method of claim 15, wherein the (meth)acrylate functional silsesquioxane is present in the coating composition in an amount ranging from 10 to 60 weight percent based on the total weight of the coating composition.
